(19) United States
(12) Patent Application Publication
(10) Pub. No.: US 2003/0036969 A1
(43) Pub. Date: Feb. 20, 2003

(54) Method for developing and distributing photographs

(76) Inventors: Shlomo Turgeman, Ramat Efal (IL); Moshe Zucker, Bnei Brak (IL)

Correspondence Address: Dekel Patent Ltd., Beit HaRof'im, Room 27, 18 Menuha VeNahala Street, Rehovot, IL

(21) Appl. No.: 10/093,912

(22) Filed: Mar. 11, 2002

(30) Foreign Application Priority Data
Aug. 16, 2001 (IL) 144937

(51) Int. Cl. G06F 17/60

(52) U.S. Cl. 705/26

(57) ABSTRACT

A method including bringing film for development to a photography store, developing the film into images, transmitting the images by a telecommunications link to access apparatus accessible by a customer, ordering at least one of the images as a finished photographic product, and receiving the order.

### FIELD OF THE INVENTION

The present invention relates generally to methods for developing and distributing photographs, and particularly to transforming a photograph store into a computerized system for developing and distributing photographs by telecommunications links.

### BACKGROUND OF THE INVENTION

Systems for developing and distributing photographs by telecommunications links are well known in the art. In a typical prior art system, a user can send negatives for development by regular mail to a development center. The development center develops the negatives and sends proofs of the pictures to the user by e-mail. The user can select which pictures he/she wants for final developed copies, the size and type (e.g., glossy or mat) of photograph, and what format (e.g., CD, slide, print or digital format).

### SUMMARY OF THE INVENTION

The present invention seeks to provide an improved computerized method or system for developing and distributing or selling photographs by telecommunications links. In contrast to the prior art, in the present invention, the customer does not have to mail his/her pictures for development to a central depository. Rather in the present invention, the customer brings his/her negatives for development to a local neighborhood photography store. The invention then transforms the neighborhood store into a full service computerized system for developing and selling photographs by telecommunications links.

In one preferred embodiment, the system scans photographs or negatives in a development laboratory or studio, stores scanned pictures in an accessible database, and enables users to order developed photographs, copies and other finished photographic products via the Internet or any other computer network. The invention is thus doubly advantageous over the prior art: the individual customer still receives personal attention from the local store instead of a faceless Internet server, and the local store can compete effectively with the Internet developers.

The system enables a distributor of photographic goods and services to monitor and control purchases, sales, supplies, inventories and orders of individual stores that use the distributor's goods and services. For example, the system of the invention may be used by major firms of photographic goods and services, such as FUJI or KODAK, to check if local neighborhood stores are actually using the photographic supplies, such as photographic film or paper, that are supposed to be purchased from the firm, as opposed to the neighborhood stores buying lesser quality supplies from cheaper, non-qualified suppliers and dealers.

There is thus provided in accordance with a preferred embodiment of the present invention a method including bringing film for development to a photography store, developing the film into images, transmitting the images by a telecommunications link to access apparatus accessible by a customer, ordering at least one of the images as a finished photographic product, and receiving the order.

In accordance with a preferred embodiment of the present invention the images are scanned to form scanned data and the scanned data is transmitted by the telecommunications link.

Further in accordance with a preferred embodiment of the present invention the images are sent to a server.

Still further in accordance with a preferred embodiment of the present invention the server may be accessed to obtain the images, and at least one of the images may be chosen and ordered.

In accordance with a preferred embodiment of the present invention the customer may be informed that the images have been sent to the access apparatus, such as by means of an e-mail message.

Further in accordance with a preferred embodiment of the present invention identifying information is transmitted which is related to the film and/or the customer.

The identifying information may include at least one or more of the following: a customer name, a customer address, a customer e-mail address, a customer telephone, a customer cell phone number, a customer fax number, a manufacturer of the film, a type of the film, a nominal number of pictures, an order number, a type and size of picture.

Still further in accordance with a preferred embodiment of the present invention the identifying information is verified with stored information.

In accordance with a preferred embodiment of the present invention information sent by the telecommunications link is processed to monitor or control photographic goods and services provided by the store. This processing may be carried out by the store or a supplier of the store.

### BRIEF DESCRIPTION OF THE DRAWINGS

The present invention will be understood and appreciated more fully from the following detailed description taken in conjunction with the appended drawings in which:

FIGS. 1 and 2 are simplified pictorial and flow-chart illustrations, respectively, of a method or system for developing and distributing or selling photographs by telecommunications links, in accordance with a preferred embodiment of the present invention.

### DETAILED DESCRIPTION OF THE PRESENT INVENTION

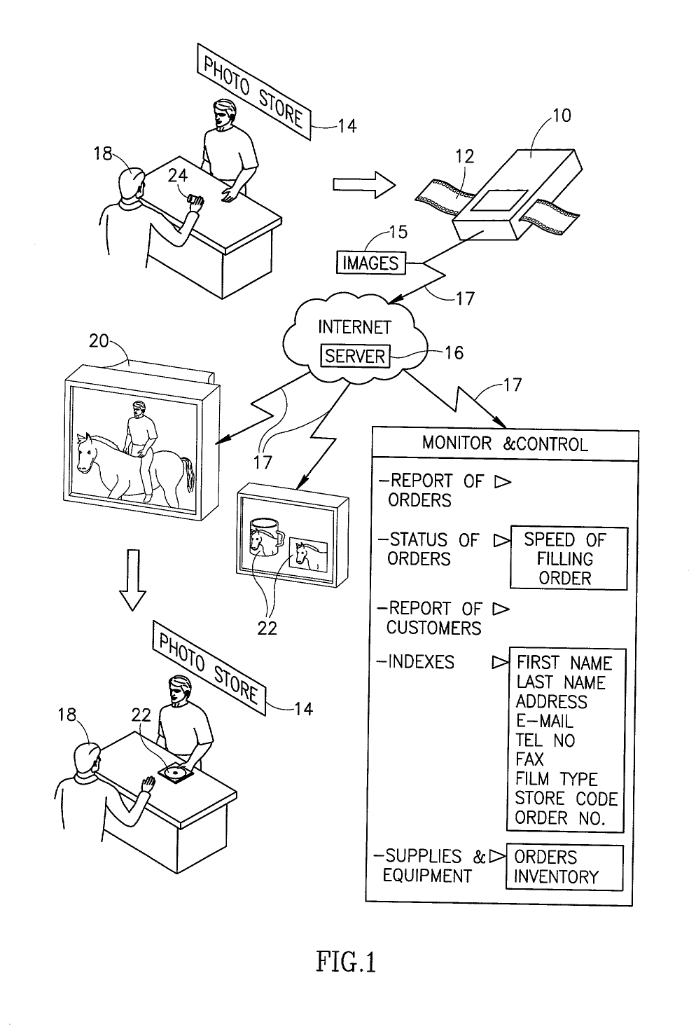

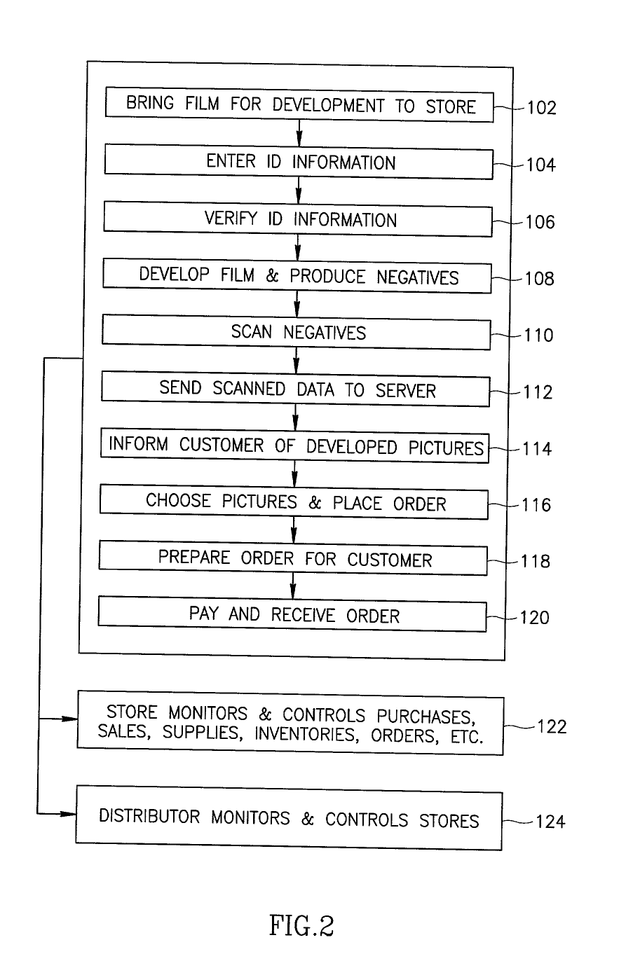

Reference is now made to FIGS. 1 and 2, which illustrate a method or system for developing and distributing or selling photographs by telecommunications links, in accordance with a preferred embodiment of the present invention.

The system may include a scanner 10 that scans a negative 12 in a development studio or laboratory of a photography store 14 to form images 15 of the pictures. The images 15 may be sent by a telecommunications link 17 to access apparatus, such as but not limited to, a network server 16, which may be accessible through the Internet. Each negative 12, preferably in an inverted format that looks like a positive, may be displayed to a customer 18, such as on a PC or dedicated Internet picture viewer 20 in the customer's home, in order for the customer to choose and place orders for pictures. In addition to the pictures themselves, the system may also present any other kind of finished photographic product 22 in the display to the customer 18, such as but not limited to, mugs with pictures printed thereon or envelopes with pictures and custom graphics chosen by the customer.

In one embodiment of the invention, the customer 18 brings a film 24 for development to local photography store 14 (step 102, FIG. 2). Any kind of identifying information may be entered and stored with respect to the film (step 104), such as but not limited to, the customer name, address, e-mail address, telephone, cell phone and fax, and also the manufacturer of the film, type of film, nominal number of pictures, order or purchase number, type and size of picture, etc. The store may verify the customer identifying information with stored information to confirm if the customer is previously known and identified in the system (step 106).

The store develops the film and produces negatives (step 108). The scanner scans the negatives (step 110), such as but not limited to, a scanning resolution of 100×100 dpi, and sends the scanned pictures along with any identifying or customer data to the server (step 112). An OCR software package may optionally be used to provide characters (letters and/or numerals) on the negative separately from the picture itself, or to read and process any characters. The pictures may be sent to the server in any format, such as but not limited to, a JPEG file or smaller THUMBNAIL files, or any combination of formats, for example.

The customer is then informed that the pictures are developed (step 114). This may be accomplished, for example, by means of a web site associated with the system that informs the customer, such as by means of an e-mail message, that the pictures are developed and may be viewed on the web site. It is noted that the term e-mail message encompasses any kind of electronic message, such as but not limited to, a beeper or pager message or an SMS message on a cell phone. The customer may then enter the site, and choose and order pictures, copies and other goods and services or finished photographic products (step 116). The customer may optionally share the pictures with friends or relatives via the Internet, for example, such as with appropriate authorization, pricing and billing from the store. The store receives the order and prints the pictures in the desired format (such as glossy pictures or a CD), and prepares any other items or finished photographic products 22 that have been ordered (step 118). The customer then goes to the store, pays and receives his/her order (step 120).

Any information in the system may be processed to enable the photography store 14 to monitor and control purchases, sales, supplies, inventories, orders and the like (step 122). The processed information may additionally or alternatively enable a distributor of photographic goods and services to monitor and control purchases, sales, supplies, inventories, orders and the like, of individual stores that use the distributor's goods and services (step 124). The processed information may be analyzed to improve sales, to target marketing to different sectors of the population or to assess inventories, for example.

It will be appreciated by person skilled in the art that the present invention is not limited by what has been particularly shown and described herein above. Rather the scope of the present invention is defined only by the claims that follow:

What is claimed is:

1. A method comprising:
bringing film for development to a photography store;
developing said film into images;
transmitting said images by a telecommunications link to access apparatus accessible by a customer;
ordering at least one of said images as a finished photographic product; and
receiving said order.

2. The method according to claim 1 wherein said transmitting comprises scanning said images to form scanned data and transmitting said scanned data by said telecommunications link.

3. The method according to claim 1 wherein said transmitting comprises sending said images to a server.

4. The method according to claim 3 wherein said ordering comprises accessing said server to obtain said images, and choosing and ordering at least one of said images.

5. The method according to claim 1 wherein said transmitting also comprises informing said customer that said images have been sent to said access apparatus.

6. The method according to claim 5 wherein said informing comprises sending said customer an e-mail message.

7. The method according to claim 1 wherein said transmitting comprises transmitting identifying information related to at least one of said film and said customer.

8. The method according to claim 7 wherein said transmitting comprises transmitting identifying information comprising at least one of a customer name, a customer address, a customer e-mail address, a customer telephone, a customer cell phone number, a customer fax number, a manufacturer of said film, a type of said film, a nominal number of pictures, an order number, a type and size of picture.

9. The method according to claim 7 and further comprising verifying said identifying information with stored information.

10. The method according to claim 1 and further comprising processing information sent by said telecommunications link to perform at least one of monitoring and controlling of photographic goods and services provided by said store.

11. The method according to claim 10 wherein said processing is carried out by said store.

12. The method according to claim 10 wherein said processing is carried out by a supplier of said store.
